(19) United States
(12) Patent Application Publication
(10) Pub. No.: US 2013/0251403 A1
(43) Pub. Date: Sep. 26, 2013

(54) CHARGING MEMBER, PROCESS CARTRIDGE, AND ELECTROPHOTOGRAPHIC APPARATUS

(71) Applicant: CANON KABUSHIKI KAISHA, TOKYO (JP)

(72) Inventors: Hidekazu Matsuda, Susono-shi (JP); Noboru Miyagawa, Suntou-gun (JP); Satoshi Koide, Otsu-shi (JP)

(73) Assignee: CANON KABUSHIKI KAISHA, TOKYO (JP)

(21) Appl. No.: 13/899,265

(22) Filed: May 21, 2013

Related U.S. Application Data
(63) Continuation of application No. PCT/JP2012/007641, filed on Nov. 28, 2012.

(30) Foreign Application Priority Data
Dec. 19, 2011 (JP) 2011-277619

(51) Int. Cl. G03G 15/02

(52) U.S. Cl. CPC G03G 15/0208
USPC 399/111; 399/168

(57) ABSTRACT

The charging member includes: an electrically conductive support; and an electrically conductive surface layer, in which the surface layer includes a first polyrotaxane and a second polyrotaxane; the first polyrotaxane has a structure in which a first straight-chain molecule passes through an inside of a ring of a first cyclic molecule; the second polyrotaxane has a structure in which a second straight-chain molecule passes through an inside of a ring of a second cyclic molecule; and the first polyrotaxane and the second polyrotaxane are bound together through formation of a chemical bond between the first cyclic molecule and the second cyclic molecule.

### CROSS-REFERENCE TO RELATED APPLICATIONS

This application is a continuation of International Application No. PCT/JP2012/007641, filed Nov. 28, 2012, which claims the benefit of Japanese Patent Application No. 2011-277619, filed Dec. 19, 2011.

### BACKGROUND OF THE INVENTION

1. Field of the Invention

The present invention relates to a charging member and a process cartridge for use in an electrophotographic apparatus, and an electrophotographic apparatus.

2. Description of the Related Art

A charging member is known as a member for charging an electrophotographic photosensitive member (hereinafter, referred to as “photosensitive member”) to a predetermined potential in an electrophotographic image forming apparatus. In particular, a roller charging mode using an electrically conductive roller as the charging member is widely used because the mode is preferred from the viewpoint of stability of charging.

The charging member generally has a configuration in which a surface layer containing a cross-linked urethane or the like is provided on a surface of an elastic body containing a rubber, an elastomer, or the like. There is a limit to an improvement in flexibility of the surface layer containing a cross-linked material as described above. However, owing to an increase in speed of an electrophotographic apparatus in recent years, formation of a nip between the charging member and the photosensitive member is liable to become unstable. When the formation of a nip becomes unstable, charging of the photosensitive member with the charging member also becomes unstable. As a result, streak-shaped density unevenness such as so-called banding may occur in an end portion of an electrophotographic image.

In order to solve the above-mentioned problem, Japanese Patent Application Laid-Open No. H08-211698 discloses, as a technology of stabilizing the formation of a nip with respect to the photosensitive member, a charging roller in which a surface layer is made flexible through use of an non-cross-linked material (e.g., a flexible thermoplastic resin or thermoplastic elastomer).

### SUMMARY OF THE INVENTION

However, when the inventors of the present invention used the charging roller disclosed in Japanese Patent Application Laid-Open No. H08-211698 for forming an electrophotographic image, the inventors found that a permanent compression set (hereinafter, sometimes referred to as “C set”) was liable to occur.

That is, a charging member to be used in a contact charging system is constantly in contact with a photosensitive member. Therefore, when an electrophotographic apparatus is left to stand still over a long period of time, a certain portion of the charging member remains being pressed against the photosensitive member. Then, a deformation which is not restored easily, that is, a C set may occur in that portion.

In the case where a photosensitive member is charged through use of a charging member in which a C set has occurred, when a portion in which the C set has occurred passes through a discharge region with respect to the photosensitive member, discharge occurring in a gap between the surface of the charging member and the surface of the photosensitive member becomes unstable. As a result, charging unevenness occurs on the photosensitive member, and streak-shaped density unevenness may occur also in an electrophotographic image, corresponding to the portion of the charging member in which the C set has occurred.

Thus, the present invention is directed to providing a charging member which suppresses the occurrence of streak-shaped density unevenness due to instability of a nip between a charging member and a photosensitive member and the occurrence of streak-shaped density unevenness due to a C set of the charging member over a long period of time.

Further, the present invention is directed to providing a process cartridge and an electrophotographic apparatus capable of stably forming a high-quality electrophotographic image while suppressing the occurrence of streak-shaped density unevenness.

According to one aspect of the present invention, there is provided a charging member, including: an electrically conductive support; and an electrically conductive surface layer, in which: the surface layer includes a bound substance in which a first polyrotaxane and a second polyrotaxane are bound; the first polyrotaxane has a structure in which a first straight-chain molecule passes through an inside of a ring of a first cyclic molecule, and the first straight-chain molecule has two blocking groups and the blocking groups are disposed at both terminals of the first straight-chain molecule so as to prevent the first cyclic molecule from being detached from the first straight-chain molecule; the second polyrotaxane has a structure in which a second straight-chain molecule passes through an inside of a ring of a second cyclic molecule, and the second straight-chain molecule has two blocking groups and the blocking groups are disposed at both terminals of the second straight-chain molecule so as to prevent the second cyclic molecule from being detached from the second straight-chain molecule; and the first polyrotaxane and the second polyrotaxane are bound by forming a chemical bond between the first cyclic molecule and the second cyclic molecule.

According to another aspect of the present invention, there is provided the charging member which suppresses the occurrence of streak-shaped density unevenness due to instability of a nip between a charging member and a photosensitive member and the occurrence of streak-shaped density unevenness due to a C set of the charging member over a long period of time. According to the present invention, there is also provided the process cartridge and electrophotographic apparatus capable of stably forming a high-quality electrophotographic image while suppressing the occurrence of streak-shaped density unevenness.

Further features of the present invention will become apparent from the following description of exemplary embodiments with reference to the attached drawings.

### BRIEF DESCRIPTION OF THE DRAWINGS

FIG. 1 is a schematic view illustrating an example of a polyrotaxane according to the present invention.

FIG. 2 is a cross-sectional view illustrating an example of a charging member (roller shape) of the present invention.

FIG. 3 is a cross-sectional view illustrating an example of an electrophotographic apparatus according to the present invention.

FIG. 4 is a cross-sectional view illustrating an example of a process cartridge according to the present invention.

FIG. 5 is an explanatory view illustrating an example of an extrusion molding machine with a crosshead to be used for producing a charging member according to the present invention.

FIG. 6 is an explanatory view illustrating an abutment state between the charging member of the present invention and an electrophotographic photosensitive member.

### DESCRIPTION OF THE EMBODIMENTS

The present invention is hereinafter described in more detail.

The inventors of the present invention paid attention to a compound in which a straight-chain molecule passes through the inside of a ring of a cyclic molecule typified by cyclodextrin, that is, a polyrotaxane and earnestly studied the application of the compound to an electrophotographic charging member. As a result, the inventors found that the above-mentioned objects can be effectively achieved by incorporating a polyrotaxane having a particular structure into a surface layer of a charging member, thereby completing the present invention.

A surface layer according to the present invention includes a bound substance in which a first polyrotaxane and a second polyrotaxane are bound. The first polyrotaxane has a structure in which a first straight-chain molecule passes through the inside of a ring of a first cyclic molecule, the first straight-chain molecule has two blocking groups and the blocking groups are disposed at both terminals of the first straight-chain molecule so as to prevent the first cyclic molecule from being detached from the first straight-chain molecule. The second polyrotaxane has a structure in which a second straight-chain molecule passes through the inside of a ring of a second cyclic molecule, the second straight-chain molecule has two blocking groups and the blocking groups are disposed at both terminals of the second straight-chain molecule so as to prevent the second cyclic molecule from being detached from the second straight-chain molecule. The first polyrotaxane and the second polyrotaxane are bound by forming a chemical bond between the first cyclic molecule and the second cyclic molecule.

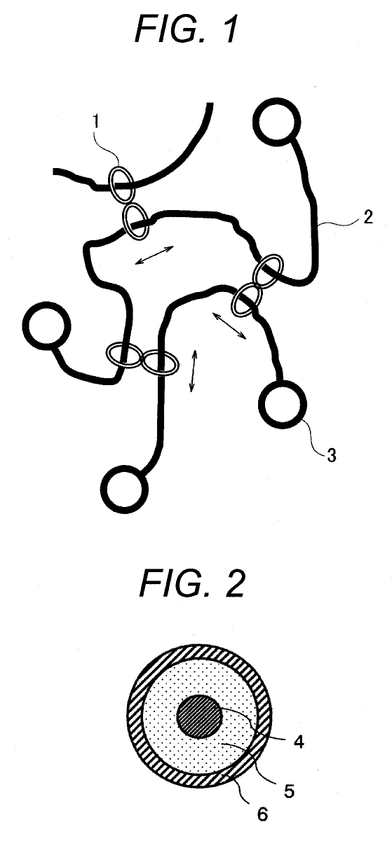

FIG. 1 is a schematic view of a polyrotaxane according to the present invention.

A straight-chain molecule 2 passes through the inside of a ring of a cyclic molecule 1, and hence the cyclic molecule 1 can move while surrounding the straight-chain molecule 2. Thus, the polyrotaxane has flexibility as compared to a rubber, an elastomer, or the like in which a number of cross-linking sites and binding sites are present.

Further, a blocking group 3 is present in an end portion of the straight-chain molecule 2 so as to prevent the cyclic molecule from being detached from the straight-chain molecule, and the cyclic molecules are bound together. Therefore, a loose bond is present while flexibility is maintained, and the occurrence of a C set due to an external force is suppressed.

It is becoming clear that banding occurs when the rotation followability of a charging member with respect to a photosensitive member becomes unstable. It is presumed that, by using the bound polyrotaxane having flexibility as a material for a surface layer, the rotation stability of the charging member increases to stabilize the formation of a nip, and hence the occurrence of streak-shaped density unevenness due to instability of the formation of a nip can be suppressed. Further, the occurrence of a C set can be reduced by binding cyclic molecules together, and hence the occurrence of streak-shaped density unevenness due to the occurrence of the C set can also be suppressed.

<Cyclic Molecule>

Any cyclic molecule can be used as the cyclic molecule as long as it is capable of including a straight-chain molecule to be described later. Herein, the inclusion refers to a state in which a straight-chain molecule passes through the inside of a ring of a cyclic molecule.

In the present invention, the term “cyclic molecule” refers to various cyclic substances including cyclic molecules. The term “cyclic molecule” refers to molecules or substances which are substantially cyclic. The term “substantially cyclic” is intended to include those which are not completely ring-closed, and also includes those which have a helical structure in which one end and the other end of a molecule overlap together without being bound together.

The cyclic molecule is not particularly limited and examples of may include various cyclodextrins (e.g., α-cyclodextrin, β-cyclodextrin, γ-cyclodextrin, dimethyl cyclodextrin, glycosyl cyclodextrin, and derivatives or modifications thereof), crown ethers, benzocrowns, dibenzocrowns, dicyclohexanocrowns, and derivatives or modifications thereof.

In the cyclodextrins, crown ethers, and the like, the size of the ring of the cyclic molecule varies depending on the kind of the cyclic molecule. Thus, the cyclic molecule to be used may be selected depending on, for example, the thickness of a straight-chain molecule to be used and the hydrophilicity/hydrophobicity or ionicity of the straight-chain molecule. In particular, at least one cyclodextrin molecule selected from the group consisting of α-cyclodextrin, β-cyclodextrin, and γ-cyclodextrin is preferred.

Those substances are substances which are relatively easily available, are inexpensive, and are present in nature as well, and are materials which are excellent in ability to include a straight-chain molecule and mechanical strength, and are suitable for exhibiting the effects of the present invention.

It is preferred that the cyclic molecule have a reaction group on the outer side of its ring. This is because, when cyclic molecules are bound together, a reaction can be easily performed through use of the reaction group. Examples of the reaction group, which depends on a cross-linking agent to be used, include a hydroxyl group, an amino group, a carboxyl group, a thiol group, and an aldehyde group. Further, it is desired to use a group which does not react with a blocking group during a block formation reaction to be described below.

<Straight-Chain Molecule>

A straight-chain molecule constituting a part of a polyrotaxane is not particularly limited as long as it is a straight-chain molecule or substance which is included by a cyclic molecule and is capable of being integrated without using a covalent bond. It is to be noted that, in the present invention, the term “straight-chain molecule” refers to molecules including polymers and all the other substances satisfying the above-mentioned requirements.

Further, in the present invention, the term “straight-chain” in the “straight-chain molecule” means a substantially “straight-chain”. That is, as long as a cyclic molecule which is a rotor can rotate, or a cyclic molecule can slide or move while including a straight-chain molecule, the straight-chain molecule may have a branched chain. Further, as long as a cyclic molecule can slide or move while including a straight-chain molecule, the straight-chain molecule may be bent or have a helical shape. Further, the length of the “straight-chain” is not particularly limited as long as a cyclic molecule can slide or move while including a straight-chain molecule.

Examples of the straight-chain molecule include: hydrophilic polymers such as polyethylene glycol, polypropylene glycol, polytetrahydrofuran, polyvinyl alcohol, and polyvinylpyrrolidone, poly(meth)acrylic acid, cellulose-based resins (e.g., carboxymethylcellulose, hydroxyethylcellulose, and hydroxypropylcellulose), polyacrylamide, polyethylene oxide, polyvinyl acetal-based resins, polyvinyl methyl ether, polyamines, polyethyleneimine, casein, gelatin, and starch and/or copolymers thereof; hydrophobic polymers such as polyolefin-based resins (e.g., polyethylene, polypropylene, and copolymer resins thereof with other olefin-based monomers), polyester resins, polyvinyl chloride resins, polystyrene-based resins (e.g., polystyrene and acrylonitrile-styrene copolymer resins), acrylic resins (e.g., polymethyl methacrylate, (meth)acrylic acid ester copolymers, and acrylonitrile-methyl acrylate copolymer resins), polycarbonate resins, polyurethane resins, vinyl chloride-vinyl acetate copolymer resins, and polyvinyl butyral resins; and derivatives or modifications thereof. Further examples thereof include polyisoprene, polyisobutylene, polybutadiene, and polydimethylsiloxane. Of those, at least one selected from the group consisting of polyethylene glycol, polypropylene glycol, polyisoprene, and polybutadiene is preferred.

Those substances are materials which are relatively easily available, are inexpensive, are excellent in ability to be included by a cyclic molecule, have high mechanical strength, and are suitable for exhibiting the effects of the present invention.

The weight-average molecular weight of the straight-chain molecule is 1,000 or more and 1,000,000 or less, preferably 3,000 or more and 500,000 or less, more preferably 5,000 or more and 300,000 or less.

It is preferred that both terminals of the straight-chain molecule have reaction groups so as to facilitate a reaction with a blocking group to be described later. Examples of the reaction group, which depends on a blocking group to be used, include a hydroxyl group, an amino group, a carboxyl group, and a thiol group.

<Blocking Group>

The polyrotaxane includes two kinds of molecules, i.e., a cyclic molecule as a rotor and a straight-chain molecule as an axis, and blocking groups are disposed at both terminals of the axis so as to prevent the rotor from being detached from the axis. Herein, the blocking group refers to various groups including low-molecular-weight groups and high-molecular-weight groups.

There is given a method involving using bulky groups as the blocking groups so as to physically prevent a cyclic molecule from being detached from a straight-chain molecule. Further, there is also given a method involving using ionic groups as the blocking groups so as to electrically prevent a cyclic molecule from being detached from a straight-chain molecule through the repulsion of the ionicity of the blocking groups and the ionicity of the cyclic molecule.

Specific examples of the blocking groups include: dinitrophenyl groups such as a 2,4-dinitrophenyl group and a 3,5-dinitrophenyl group; cyclodextrins; adamantane groups; trityl groups; fluoresceins; pyrenes; and derivatives or modifications thereof.

<Chemical Bond>

In the polyrotaxane to be used in the present invention, a cyclic molecule of a first polyrotaxane and a cyclic molecule of a second polyrotaxane are bound together through a chemical bond. At this time, two or more polyrotaxane molecules to be bound together through a chemical bond may be the same or different from each other. In this case, the chemical bond may be a simple bond or a bond through various atoms or molecules.

<Binder>

A known binder may be used as a substance for binding cyclic molecules through a chemical bond. Examples thereof may include cyanuric chloride, trimesoyl chloride, terephthaloyl chloride, epichlorohydrin, dibromobenzene, glutaraldehyde, phenylene diisocyanate, tolylene diisocyanate (e.g., tolylene 2,4-diisocyanate), 1,1′-carbonyldiimidazole, and divinylsulfone. Further examples thereof may include various coupling agents such as silane coupling agents (e.g., various alkoxysilanes) and titanium coupling agents (e.g., various alkoxytitaniums).

Further examples thereof may include stilbazolium salt-based photocrosslinking agents such as formylstyrylpyridium, and other photocrosslinking agents such as photocrosslinking agents by photodimerization, and specific examples thereof may include cinnamic acid, anthracene, and thymines.

The molecular amount of the binder is less than 2,000, preferably less than 1,000, more preferably less than 600, most preferably less than 400.

As a cross-linked cyclic molecule, in addition to those which are formed by cross-linking the above-mentioned cyclic molecules, molecules having two or more cyclic molecular structures can also be used. In this case, for example, a molecule having two or more rings and a straight-chain molecule are mixed, and the straight-chain molecule can be caused to pass through the ring of the molecule having two or more rings to obtain a bound polyrotaxane. In this case, it is preferred that the straight-chain molecule be caused to pass through the cyclic molecule, and thereafter, both terminals of the straight-chain molecule are blocked with blocking groups.

<Method of Preparing Polyrotaxane>

First, a cyclic molecule and a straight-chain molecule are mixed to prepare a pseudopolyrotaxane in which the straight-chain molecule passes through the inside of a ring of the cyclic molecule.

The amount of the cyclic molecule through which the straight-chain molecule is caused to pass can be controlled by a mixing ratio between the cyclic molecule and the straight-chain molecule, a mixing time, and the like. It is to be noted that it is desired that the straight-chain molecule be not densely included in the cyclic molecule. When the straight-chain molecule is not densely included in the cyclic molecule, the degree of freedom of mobility of the cyclic molecule with respect to the straight-chain molecule is held, and a surface layer having both excellent flexibility and recoverability can be obtained.

Next, both terminals of the straight-chain molecule are blocked with blocking groups so as to prevent the cyclic molecule from being detached from the pseudopolyrotaxane obtained in the above to prepare a blocked polyrotaxane.

The binding of two or more blocked polyrotaxanes is performed by binding the cyclic molecules of the obtained blocked polyrotaxane through a chemical bond to obtain a bound polyrotaxane.

Further, in addition to the above-mentioned method, a polyrotaxane can be obtained through use of a cyclic molecule in which two or more cyclic molecules are bound together through a chemical bond as follows.

A cyclic molecule in which two or more cyclic molecules are bound together through a chemical bond and a straight-chain molecule are mixed to obtain a pseudopolyrotaxane in which the straight-chain molecule passes through the cyclic molecule. Then, both terminals of the straight-chain molecule are blocked with blocking groups so as to prevent the cyclic molecule from being detached from the straight-chain molecule.

<Case of Using Cyclodextrin as Cyclic Molecule>

Cyclodextrin is a cyclic molecule, the inside of its ring is hydrophobic, and the property of taking a hydrophobic molecule into the inside of the ring in a water medium is utilized. Thus, in general, the synthesis of a rotaxane using cyclodextrin is performed in a water medium through use of a hydrophobic axle molecule.

<Case of Using Crown Ether as Cyclic Molecule>

Crown ether is also a cyclic molecule and has the property of taking a cationic molecule into the inside of its ring. Thus, crown ether tends to form a rotaxane together with a cationic axle molecule. This is a method using an ionic interaction, and hence, in general, a reaction is mostly performed in a low-polarity solvent. Specifically, it is preferred that crown ether be used as a cyclic molecule and a molecule having a secondary ammonium salt be used as a straight-chain molecule.

<Other Polymers>

The surface layer of the charging member of the present invention may contain other polymers in such a range as not to impair the effect, in addition to the above-mentioned polyrotaxane. At this time, the polyrotaxane and other polymers may be bound together through a chemical bond or may be merely mixed to be in a so-called polymer blend state.

As the other polymers, for example, known binders can be adopted. Examples thereof may include resins, natural rubbers, vulcanized natural rubbers, and synthetic rubbers.

Resins such as a thermosetting resin and a thermoplastic resin can each be used as the resin. Of those, a fluororesin, a polyamide resin, an acrylic resin, a polyurethane resin, a silicone resin, and a butyral resin are more preferred.

An ethylene-propylene-diene copolymer (EPDM), a styrene-butadiene copolymer rubber (SBR), a silicone rubber, a urethane rubber, an isoprene rubber (IR), a butyl rubber, an acrylonitrile-butadiene copolymer rubber (NBR), a chloroprene rubber (CR), an acrylic rubber, and an epichlorohydrin rubber can each be used as the synthetic rubber.

One kind of those substances may be used alone, or two or more kinds thereof may be used as a mixture. A copolymer thereof is also permitted. It is to be noted that, out of those substances, a resin is preferably used as any other binder resin to be used in the surface layer from the following viewpoints. The photosensitive member and any other member are not contaminated, and high releasability is obtained.

<Electrically Conductive Material>

It is preferred that the electrically conductive material be further added to a polyrotaxane. As conductive particles, there are given electron conductive particles and ion conductive particles.

<Additive Other than Electrically Conductive Material>

In addition to the above-mentioned conductive material, a filler or the like made of an inorganic compound may be added to the surface layer of the charging member of the present invention.

<Volume Resistivity of Surface Layer>

It is preferred that the volume resistivity of the surface layer be 1×10³ Ω·cm or more and 1×10¹⁵ Ω·cm or less in an environment of a temperature of 23° C. and a humidity of 50% RH. By setting the volume resistivity of the surface layer in the above-mentioned range, an appropriate current amount is kept, and a satisfactory image can be obtained.

<Charging Member>

The charging member of the present invention has a configuration including at least an electrically conductive support and a surface layer provided on the conductive support. FIG. 2 is a cross-sectional view illustrating an example of a charging member in a roller shape (charging roller) in which an elastic layer 5 is provided on an electrically conductive support 4, and a surface layer 6 is further provided thereon, the view being perpendicular to a longitudinal direction of the roller.

<Electrically Conductive Support>

The conductive support used in the charging member of the present invention has conductivity and has a function of supporting a layer such as the surface layer to be provided on the support. As a material for the support, there may be given metals such as iron, copper, stainless steel, aluminum, and nickel, and alloys thereof.

<Elastic Layer>

The rubbers and resins given in the foregoing as examples of the binder resin component of the surface layer can each be used as a material used for the elastic layer.

Preferred examples thereof include an epichlorohydrin rubber, an acrylonitrile-butadiene copolymer rubber (NBR), a chloroprene rubber, a urethane rubber, a silicone rubber, and thermoplastic elastomers such as a styrene/butadiene/styrene block copolymer (SBS) and a styrene/ethylenebutylene/styrene block copolymer (SEBS). Of those, a polar rubber is more preferably used because resistance adjustment is easily performed. An epichlorohydrin rubber and NBR are still more preferably used because the control of the resistance and hardness of the elastic layer is more easily performed.

The epichlorohydrin rubber can exert good conductivity even when the addition amount of conductive particles is small because the polymer itself has conductivity in a middle resistance region. In addition, the rubber can reduce a variation in electrical resistance with a position, and is hence suitably used as a polymer elastic body. Examples of the epichlorohydrin rubber include an epichlorohydrin homopolymer, an epichlorohydrin-ethylene oxide copolymer, an epichlorohydrin-allyl glycidyl ether copolymer, and an epichlorohydrin-ethylene oxide-allyl glycidyl ether terpolymer. Of those, an epichlorohydrin-ethylene oxide-allyl glycidyl ether terpolymer is particularly suitably used because the terpolymer shows stable conductivity in the middle resistance region. The conductivity and processability of the epichlorohydrin-ethylene oxide-allyl glycidyl ether terpolymer can be controlled by arbitrarily adjusting its degree of polymerization or composition ratio.

The elastic layer, which may be formed of the epichlorohydrin rubber alone, may contain any other general rubber as required while using the epichlorohydrin rubber as a main component. Examples of the other general rubber include an ethylene/propylene rubber (EPM), an ethylene-propylene-diene copolymer (EPDM), an acrylonitrile-butadiene copolymer rubber (NBR), a chloroprene rubber, a natural rubber, an isoprene rubber, a butadiene rubber, a styrene-butadiene rubber, a urethane rubber, and a silicone rubber. The elastic layer may also contain a thermoplastic elastomer such as a styrene/butadiene/styrene block copolymer (SBS) or a styrene/ethylenebutylene/styrene block copolymer (SEBS). When the general rubber is incorporated, its content is preferably 1 part by mass or more and 50 parts by mass or less with respect to 100 parts by mass of the materials for the elastic layer.

The elastic layer preferably has a volume resistivity of 10² Ω·cm or more and 10¹⁰ Ω·cm or less, which is measured in an environment of a temperature of 23° C. and a humidity of 50% RH. In addition, conductive particles such as carbon black, an electrically conductive metal oxide, an alkali metal salt, or an ammonium salt can be appropriately added for adjusting the volume resistivity. When a polar rubber is used as a material for the elastic layer, the ammonium salt is particularly preferably used.

The elastic layer can be formed by adhering a sheet- or tube-shaped layer formed so as to have a predetermined thickness in advance to the conductive support, or by coating the support with the layer. Alternatively, the elastic layer can be produced by integrally extruding the conductive support and the materials for the elastic layer with an extruder provided with a crosshead.

A known method such as mixing with a ribbon blender, a Nauta mixer, a Henschel mixer, a Super mixer, a Banbury mixer, or a pressure kneader can be employed as a method of dispersing substances such as conductive particles, insulating particles, and a filler in the materials for the elastic layer.

It is preferred that the charging member of the present invention have a so-called crown shape in which a center portion in a longitudinal direction is thick and the thickness decreases toward both terminals in the longitudinal direction, from the viewpoint of making a nip width in the longitudinal direction of the charging member uniform with respect to the photosensitive member. Regarding the crown amount, it is preferred that a difference between an outer diameter of the center portion and an outer diameter of a position which is 90 mm away from the center portion be 30 μm to 200 μm.

<Method of Forming Surface Layer>

Polyrotaxanes in a bound state can be dissolved in a solvent and applied onto an electrically conductive support by a coating method such as dipping to provide a surface layer on the conductive support. Alternatively, the following method may be performed: a solution in which blocked polyrotaxanes and a binder are mixed is applied onto an electrically conductive support by a coating method such as dipping; and the solution is dried to bind polyrotaxanes.

<Verification Method>

A polyrotaxane can be identified by 1H-NMR, GPC, or the like.

<Electrophotographic Apparatus>

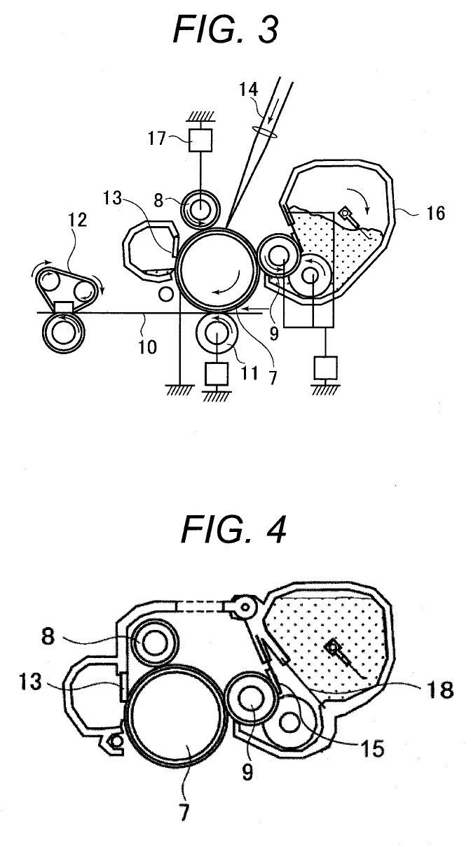

FIG. 3 illustrates a schematic configuration of an electrophotographic apparatus including a charging roller according to the present invention.

An electrophotographic photosensitive member 7 has a drum shape including a photosensitive layer on an electrically conductive substrate. Then, the electrophotographic photosensitive member 7 is rotary-driven at a predetermined circumferential speed (process speed) in a direction indicated by an arrow.

A charging device includes a charging roller 8 which is brought into abutment with the electrophotographic photosensitive member 7 under a predetermined pressure. The charging roller 8 is driven following the rotation of the electrophotographic photosensitive member 7, and further, the electrophotographic photosensitive member is charged to a predetermined potential by being supplied with a predetermined DC voltage from a power supply for charging 17. Further, as a latent image forming device (not shown) for forming an electrostatic latent image on the electrophotographic photosensitive member 7, for example, an exposing device such as a laser beam scanner is used. When the uniformly charged electrophotographic photosensitive member is irradiated with exposure light 14 corresponding to image information, an electrostatic latent image is formed.

A developing roller 9 provided in a developing device 16 is provided so as to be close to or in contact with the electrophotographic photosensitive member 7, and in the case of reversal development, the developing roller visualizes and develops an electrostatic latent image into a toner image with toner subjected to an electrostatic treatment so as to have the same polarity as the charged polarity of the electrophotographic photosensitive member. A transferring roller 11 transfers the toner image from the electrophotographic photosensitive member to a transfer material 10 (the transfer material is conveyed by a sheet-feeding system having a conveying member). A cleaning device has a blade-type cleaning member 13 and a recovery container, and mechanically scrapes transfer residual toner remaining on the electrophotographic photosensitive member after the transfer to recover the toner. A fixing device 12 is composed of a heated roll and the like, and fixes the transferred toner image onto the transfer material 10 and discharges the resultant to the outside of the apparatus.

<Process Cartridge>

A process cartridge (FIG. 4) obtained by integrating, for example, an electrophotographic photosensitive member, a charging device, a developing device, and a cleaning device, and designed so as to be attachable to and detachable from an electrophotographic apparatus can also be used. That is, the process cartridge is a process cartridge including a charging member and an electrophotographic photosensitive member as an object to be charged, which are integrated with each other, the process cartridge being attachable to and detachable from a main body of an electrophotographic apparatus, in which the charging member is the above-mentioned charging member. In addition, the electrophotographic apparatus includes at least a process cartridge, an exposing device, and a fixing device, in which the process cartridge is the above-mentioned process cartridge.

Hereinafter, the present invention is described in more detail by way of specific examples. However, the present invention is not limited to the following examples.

### Production Example A-1

(Activation of Both Terminals of Straight-Chain Molecule)

100 g of polyethylene glycol (hereinafter, referred to as PEG; weight-average molecular weight: 10,000) were dissolved in 500 ml of methylene chloride, and the solution was placed in an argon atmosphere. To the solution, 20 g of 1,1-carbonyldiimidazole was added, and the resultant solution was reacted with stirring at room temperature for 24 hours in an argon atmosphere.

The reaction product thus obtained was poured into diethyl ether stirred at a high speed. After the resultant was left to stand still for 1 hour, a liquid containing a precipitate was centrifuged to take out the precipitate. Thus, 90 g of a product were obtained.

The product thus obtained was dissolved in 500 ml of methylene chloride, and the solution was added dropwise to 500 ml of ethylene diamine over 3 hours. After the dropwise addition, the product was stirred for 1 hour. The reaction product thus obtained was subjected to a rotary evaporator to remove methylene chloride and dissolved in 1 liter of water. The solution was placed in a dialysis tube (molecular weight cut-off: 8,000), and dialyzed in water for 7 days.

The obtained dialysate was dried with a rotary evaporator, and the dried product was further dissolved in 500 ml of methylene chloride. The solution was added to 1 liter of diethyl ether to re-precipitate the dried product. A precipitate was taken out of a liquid containing the precipitate by centrifugation, and the precipitate was dried in vacuum at 40° C. for 2 hours to obtain 68 g of a product (hereinafter, abbreviated as DAT-PEG) in which an amino group was introduced into both terminals of PEG. It is to be noted that commercially available polyethylene glycol-bis-amine can also be used instead of this product.

(Preparation of Pseudopolyrotaxane)

20 g of the DAT-PEG (weight-average molecular weight: about 10,000) obtained as described above and 80 g of α-cyclodextrin were dissolved in pure water at 80° C., and thereafter, the solution was refrigerated at 5° C. for 24 hours to prepare a polyrotaxane. After that, the polyrotaxane was dried in vacuum at 40° C. for 24 hours.

(Preparation of Blocked Polyrotaxane)

A solution in which 500 ml of N,N-dimethylformamide (hereinafter, abbreviated as DMF) and 125 ml of 2,4-dinitrofluorobenzene were mixed was added dropwise to the pseudopolyrotaxane obtained as described above, and the mixture was reacted at room temperature in an argon atmosphere. After 24 hours, 2 liters of dimethyl sulfoxide (hereinafter, abbreviated as DMSO) were added to the mixture to obtain a transparent solution. The solution thus obtained was added dropwise to 5 liters of water which was stirred vigorously to obtain a pale yellow precipitate. The precipitate was dissolved again in 3 liters of DMSO, and the solution was added dropwise to 10 liters of a 0.1% sodium chloride aqueous solution which was stirred vigorously to produce a precipitate again. The precipitate was washed with water and methanol, and the washed precipitate was subjected to centrifugation. The substance thus obtained was dried in vacuum at 50° C. for 24 hours to obtain a blocked polyrotaxane A-1 in which terminals of a straight-chain molecule were blocked.

### Production Example A-2 to Production Example A-7

Blocked polyrotaxanes A-2 to A-7 were obtained by the same method as that of Production Example A-1 with the exception that straight-chain molecules as starting materials were changed as described in Table 1.

### Production Example A-8

(Activation of Both Terminals of Straight-Chain Molecule)

10 g of PEG (weight-average molecular weight: 50,000), 50 mg of 2,2,6,6-tetramethyl-1-piperidinyloxy radical (TEMPO), and 0.25 g of sodium bromide were dissolved in 110 ml of water.

To the solution thus obtained, 2.5 ml of a commercially available sodium hypochlorite aqueous solution (effective chlorine concentration: about 5%) were added, and the mixture was reacted at room temperature with stirring.

When the reaction proceeded, the pH of the system decreased rapidly immediately after the addition. In order to keep the pH at 10 to 11, 1 N NaOH was added to the solution to adjust the pH. The decrease in pH stopped within 3 minutes, and the solution was stirred further for 10 minutes. An excess amount of ethanol was added to the solution to quench the reaction.

Extraction was repeated three times with 50 ml of methylene chloride to extract components other than mineral salts, and thereafter, methylene chloride was distilled off with an evaporator.

The resultant was dissolved in 250 ml of hot ethanol and left to stand overnight in a refrigerator at a temperature of −4° C. to deposit a PEG-carboxylic acid, that is, PEG with both terminals replaced by a carboxylic acid (—COOH), and the deposited PEG-carboxylic acid was recovered by centrifugation.

The cycle of dissolution in hot ethanol-deposition-centrifugation was repeated several times, finally followed by drying in vacuum, to obtain a PEG-carboxylic acid. A yield was 95% or more, and a carboxylation ratio was 95% or more.

(Preparation of Pseudopolyrotaxane)

6 g of the PEG-carboxylic acid obtained by the above-mentioned method and 24 g of β-cyclodextrin were each dissolved in 100 ml of separately prepared hot water at 70° C., and both the solutions were mixed. After that, the mixed solution was left to stand still in a refrigerator (temperature: 4° C.) for 3 days. A pseudopolyrotaxane deposited in a cream form was freeze-dried and recovered.

(Preparation of Blocked Polyrotaxane)

To the pseudopolyrotaxane obtained as described above, a solution in which 0.26 g of adamantaneamine, 0.60 g of a BOP reagent (benzotriazol-1-yl-oxy-tris(dimethylamino)phosphonium-hexafluorophosphate), and 0.28 ml of diisopropylethylamine were dissolved in 120 ml of dry DMF was added, and the mixture was shaken thoroughly and left to stand still overnight in a refrigerator.

After that, 120 ml of methanol were added to the resultant solution, followed by stirring and centrifugation, and then a supernatant was removed. Next, 200 ml of a mixed solution of DMF and methanol (1:1) were added to the resultant solution, and the same operation was performed twice.

The same operation was further performed twice with 200 ml of methanol, and the obtained precipitate was dried in vacuum and dissolved in 140 ml of DMSO.

The solution was added dropwise to 1,400 ml of pure water to deposit a polyrotaxane. The deposited polyrotaxane was recovered by centrifugation and dried in vacuum.

A similar re-precipitation operation was further performed to obtain 16 g of a polyrotaxane A-8.

### Production Example A-9 to Production Example A-11

Blocked polyrotaxanes A-9 to A-11 were obtained by the same method as that of Production Example A-8 with the exception that straight-chain molecules as starting materials were changed as described in Table 1.

### Production Example A-12

A blocked polyrotaxane A-12 was obtained in the same way as in Production Example A-1 with the exception that γ-cyclodextrin was used instead of α-cyclodextrin as a cyclic molecule.

### Production Example A-13 to Production Example A-15

Blocked polyrotaxanes A-13 to A-15 were obtained by the same method as that of Production Example A-12 with the exception that straight-chain molecules as starting materials were changed as described in Table 1.

### Production Example A-16

### Synthesis 1

### Synthesis of Bifunctional Crown Ether

10.8 g (24.1 mmol) of dibenzo-24-crown-8 and 14.0 g (99.1 mmol) of hexamethylenetetramine were dissolved in 50 ml of trifluoroacetic acid in an argon atmosphere, and the solution thus obtained was stirred at 80° C. overnight. 30 ml of water were added to the solution, and the mixture was stirred at room temperature for 2 hours. After that, chloroform was added to the mixture to separate an oil layer, and chloroform of the oil layer was distilled off under reduced pressure.

The residue was purified by silica gel column chromatography (eluent: chloroform was used first, and then a 2% methanol-chloroform mixed solution was used) to obtain 10.5 g (20.8 mmol, 86%) of a diformyl body as a white solid.

10.5 g (20.8 mmol) of the diformyl body were dissolved in 120 ml of THF. After that, 3.95 g (83.2 mmol) of lithium aluminum hydride were added to the solution little by little in an ice bath to be suspended, and the suspension was refluxed overnight. Excess lithium aluminum hydride was decomposed with a saturated sodium sulfate aqueous solution, and a deposited solid was subjected to suction filtration, followed by washing with THF, and THF was distilled off from the filtrate under reduced pressure. The residue was purified by silica gel column chromatography (eluent: chloroform was used first, and then a 3% methanol-chloroform mixed solution was used) to obtain 8.90 g (17.5 mmol; 84%) of a diol as a white solid.

2.5 ml of DMF were added to dissolve 0.254 g (0.500 mmol) of the diol, and 0.30 ml (4.10 mmol) of thionyl chloride was added to the resultant solution. The solution was stirred at room temperature for 30 minutes, and water was added thereto, followed by suction filtration, to obtain 0.214 g (0.392 mmol; 78%) of a chloride. First, 0.214 g (0.392 mmol) of the chloride, and then 0.359 g (2.83 mmol) of potassium thioacetate were added to 4.0 ml of DMF, and the mixture was stirred at room temperature overnight. Water was added to the solution, and then the mixture was extracted with chloroform. The solvent was distilled off under reduced pressure. The residue was purified by silica gel column chromatography (eluent/chloroform) to obtain 0.185 g (0.294 mmol; 75%) of a bifunctional crown ether containing a thioester group as a pale brown solid.

### Synthesis 2

103 g (1.10 mol) of tert-butyl chloride were added to 51.0 g (0.550 mol) of toluene, and 3.04 g (0.0230 mol) of anhydrous aluminum chloride were added little by little over 6 hours. After that, the mixture was stirred at room temperature for 24 hours. The mixture was added to a cold diluted sulfuric acid aqueous solution. The oil layer was washed with water and then with a saturated sodium carbonate aqueous solution and dried with anhydrous magnesium sulfate, and the solvent (toluene) was distilled off under reduced pressure. The residue was purified by distillation under reduced pressure to obtain 45.3 g (0.222 mol) of 3,5-di-tert-butyltoluene as a colorless oil.

40 ml of a 5 M KOH aqueous solution were added to 21.8 g (107 mmol) of 3,5-di-tert-butyltoluene and 86 ml (1.07 mol) of pyridine. After that, 37.1 g (235 mmol) of potassium permanganate were added to the resultant solution in an ice bath little by little and refluxed overnight. 300 ml of 2 M sulfuric acid were added to the solution, followed by suction filtration, and the residue was washed with water and then with ethyl acetate. The organic layer was dried with anhydrous magnesium sulfate, and a solvent was distilled off under reduced pressure. The residue was recrystallized with n-hexane to obtain 9.83 g (41.9 mmol; 16%) of 3,5-di-tert-benzoic acid as a white solid.

14.41 g (18.8 mmol) of 3,5-di-tert-butylbenzoic acid were added to 10.0 ml (137 mmol) of thionyl chloride. The mixture was stirred at 50° C. overnight, and thereafter, excess thionyl chloride was distilled off under reduced pressure. Further, benzene was added to the resultant solution, followed by azeotropic distillation, to remove the remaining thionyl chloride. A solution obtained by dissolving the acid chloride synthesized as described above in 20 ml of THF was added dropwise little by little in an ice bath to a solution obtained by adding 4.32 g (56.4 mmol) of 3-amino-1-propanol to 20 ml of THF. After the dropwise addition, the resultant solution was stirred at room temperature for 2 hours. Then, 50 ml of water and 100 ml of 3 M HCl were added, and the solution was extracted with ethyl acetate. The extract was dried with anhydrous magnesium sulfate, and the solvent was distilled off under reduced pressure. The residue was dried under reduced pressure to obtain 5.17 g (17.7 mmol; 94%) of an amide as a white solid.

50 ml of THF were added to dissolve 5.17 g (17.7 mmol) of the amide. After that, 2.50 g (52.8 mmol) of lithium aluminum hydride were added to the solution in an ice bath, and the mixture was refluxed overnight. After the reflux, a saturated sodium sulfate aqueous solution was added to the mixture to decompose excess lithium aluminum hydride. The resultant solution was subjected to suction filtration, and the solid was washed with ethyl acetate and the solvent was distilled off from the filtrate under reduced pressure.

The residue was purified by silica gel column chromatography (eluent: chloroform was used first, and then a 3% methanol-chloroform mixed solution was used) to obtain 4.78 g (17.3 mmol) of an amine compound as a colorless oil. 40 ml of methanol were added to dissolve the amine compound, and 40 mLl of 10% HPF₆ were added to the solution with stirring little by little in an ice bath. The deposited white solid was subjected to suction filtration. Further, 100 ml of water were added to the white solid, followed by filtration, and the combined filtrate was cooled to deposit a white solid, followed by suction filtration. This operation was repeated three times. After that, the white solid was washed and filtered with acetonitrile, and the filtrate was dried with anhydrous magnesium sulfate. The solvent of the filtrate was distilled off under reduced pressure, followed by drying under reduced pressure, to obtain 7.15 g (16.9 mmol; 95%) of a compound of the following formula (I) as a white solid. The compound was used for producing a rotaxane.

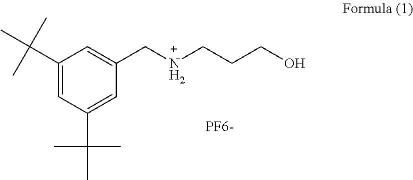

### Synthesis 3

Synthesis of Phenylene Diisocyanate-Terminated Polytetrahydrofuran:

4 ml of chloroform were added to 0.624 g (0.624 mmol) of anhydrous polytetrahydrofuran. The solution was slowly added dropwise to a solution obtained by adding 1.00 g (6.24 mmol) of m-phenylene diisocyanate to 10 ml of chloroform in an argon atmosphere. After that, 18.9 mg (30.0 μmol) of di-n-butyltin dilaurate were added to the solution, followed by stirring at room temperature for 1 day. The resultant solution was purified by distillation to obtain a phenylene diisocyanate-terminated polytetrahydrofuran as a white solid.

### Synthesis 4

Production of Polyrotaxane

1.5 ml of chloroform were added to dissolve 430 mg (0.684 mmol) of the bifunctional crown ether obtained in Synthesis 1 and 276 mg (0.653 mmol) of the compound obtained in Synthesis 2. After that, to the solution, 386 mg (0.311 mmol) of the phenylene diisocyanate-terminated polytetrahydrofuran obtained in Synthesis 3 dissolved in 0.50 ml of chloroform were added. Then, 42 mg (60 μmol) of di-n-butyltin dilaurate were added to the resultant solution, followed by stirring at room temperature for 1 day. A fraction of a high-molecular-weight substance in preparative GPC was fractionated to obtain 838 mg (introduction ratio: 80%) of a polyrotaxane as a pale brown solid.

2.00 ml of DMF were added to dissolve 820 mg (0.286 mmol) of the polyrotaxane, and 0.29 ml (2.10 mmol) of triethylamine was added to the solution. After that, 0.180 ml (1.80 mmol) of acetic anhydride was added to the solution, followed by stirring for 12 hours. Then, 30 ml of 2 M hydrochloric acid were added to the solution, and the solution was extracted with chloroform and dried with anhydrous magnesium sulfate. Then, the solvent was distilled off under reduced pressure, followed by purification by preparative GPC, to obtain 681 mg of the following N-acetylated polyrotaxane as a white solid.

Then, 30 ml of degassed methanol were added to dissolve 0.509 ml (4.50 mmol) of acetyl chloride in an argon atmosphere. In an argon atmosphere, 20 ml of the methanol solution were added to 404 gm of the N-acetylated polyrotaxane, followed by reflux for 8 hours. The solvent was distilled off under reduced pressure, followed by drying under reduced pressure, to obtain 403 mg of a blocked polyrotaxane A-16 as a yellow solid. The polyrotaxane had four thiol groups.

TABLE 1

| Production | | | |
|---|---|---|---|
| example | Cyclic molecule | Straight-chain molecule | Blocking group |
| A-1 | α-Cyclodextrin | Polyethylene glycol | 2,4-Dinitrofluorobenzene |
| | | (molecular weight: 10,000) | |
| A-2 | α-Cyclodextrin | Polyethylene glycol | 2,4-Dinitrofluorobenzene |
| | | (molecular weight: 30,000) | |
| A-3 | α-Cyclodextrin | Polyethylene glycol | 2,4-Dinitrofluorobenzene |
| | | (molecular weight: 100,000) | |
| A-4 | α-Cyclodextrin | Polyethylene glycol | 2,4-Dinitrofluorobenzene |
| | | (molecular weight: 500,000) | |
| A-5 | α-cyclodextrin | Polypropylene glycol | 2,4-Dinitrofluorobenzene |
| | | (molecular weight: 5,000) | |
| A-6 | α-Cyclodextrin | Polyisoprene | 2,4-Dinitrofluorobenzene |
| | | (molecular weight: 2,500) | |
| A-7 | α-Cyclodextrin | Polybutadiene | 2,4-Dinitrofluorobenzene |
| | | (molecular weight: 2,800) | |
| A-8 | β-Cyclodextrin | Polyethylene glycol | Adamantaneamine |
| | | (molecular weight: 50,000) | |
| A-9 | β-Cyclodextrin | Polypropylene glycol | Adamantaneamine |
| | | (molecular weight: 5,000) | |
| A-10 | β-Cyclodextrin | Polyisoprene | Adamantaneamine |
| | | (molecular weight 2,500) | |
| A-11 | β-Cyclodextrin | Polybutadiene | Adamantaneamine |
| | | (molecular weight: 2,800) | |
| A-12 | γ-Cyclodextrin | Polyethylene glycol | Sodium 2,4,6- |
| | | (molecular weight: 10,000) | trinitrobenzenesulfonate |
| A-13 | γ-Cyclodextrin | Polypropylene glycol | Sodium 2,4,6- |
| | | (molecular weight: 5,000) | trinitrobenzenesulfonate |
| A-14 | γ-Cyclodextrin | Polyisoprene | Sodium 2,4,6- |
| | | (molecular weight: 2,500) | trinitrobenzenesulfonate |
| A-15 | γ-Cyclodextrin | Polybutadiene | Sodium 2,4,6- |
| | | (molecular weight: 2,800) | trinitrobenzenesulfonate |
| A-16 | Dibenzo-24- | Secondary ammonium salt | 3,5-Di-tert-butyltoluene |
| | crown-8-ether | derivative | |

### Production Example B-1

### Production of Conductive Particles

140 g of methylhydrogenpolysiloxane were added to 7.0 kg of silica particles (average particle diameter: nm; volume resistivity: 1.8×10¹² Ω·cm) while an edge runner was being operated, and the contents were mixed with stirring under a line load of 588 N/cm (60 kg/cm) for 30 minutes. The stirring speed at this time was 22 rpm. To the mixture, 7.0 kg of carbon black “#52” (trade name, manufactured by Mitsubishi Chemical Corporation) were added over 10 minutes while an edge runner was being operated. The resultant mixture was further mixed with stirring for 60 minutes under a line load of 588 N/cm (60 kg/cm). Thus, carbon black was allowed to adhere to the surfaces of the silica particles covered with methylhydrogenpolysiloxane, and thereafter, the silica particles were dried at 80° C. for minutes through use of a drier to produce composite conductive particles. The stirring speed at this time was rpm. It is to be noted that the average particle diameter of each of the obtained composite conductive particles was 15 nm, and the volume resistivity thereof was 1.1×10² Ω·cm.

### Production Example C-1

### Production of Elastic Roller

A bar made of stainless steel with a diameter of 6 mm and a length of 252.5 mm was coated with a thermosetting adhesive (“Metaloc U-20” trade name, manufactured by Toyokagaku Kenkyuusho Co. Ltd.) and dried to be used as an electrically conductive support. Materials described in Table 2 were mixed and kneaded with a sealed mixer adjusted to a temperature of 50° C. for 10 minutes to prepare a material compound.

TABLE 2

| | | |
|---|---|---|
| Epichlorohydrin rubber | 100 | parts by mass |
| (EO-EP-AGC terpolymer, EO/EP/AGE = | | |
| 73 mol %/23 mol %/4 mol %) | | |
| Calcium carbonate | 65 | parts by mass |
| Aliphatic polyester-based plasticizer | 8 | parts by mass |
| Zinc stearate | 1 | part by mass |
| 2-Mercaptobenzimidazole (MB) (antioxidant) | 0.5 | part by mass |
| Zinc oxide | 2 | parts by mass |
| Quaternary ammonium salt | 2 | parts by mass |
| Carbon black | 4.5 | parts by mass |
| (Volume-average particle diameter: 100 nm, | | |
| volume resistivity: 0.1 Ω · cm) | | |

0.8 Part by mass of sulfur as a vulcanizer, 1 part by mass of dibenzothiazyl sulfide (DM) as a vulcanization accelerator, and 0.5 part by mass of tetramethylthiuram monosulfide (TS) were added to the material compound, and the mixture was kneaded with a twin-roll mill cooled to a temperature of 20° C. for 10 minutes. Thus, a compound for an elastic layer was obtained.

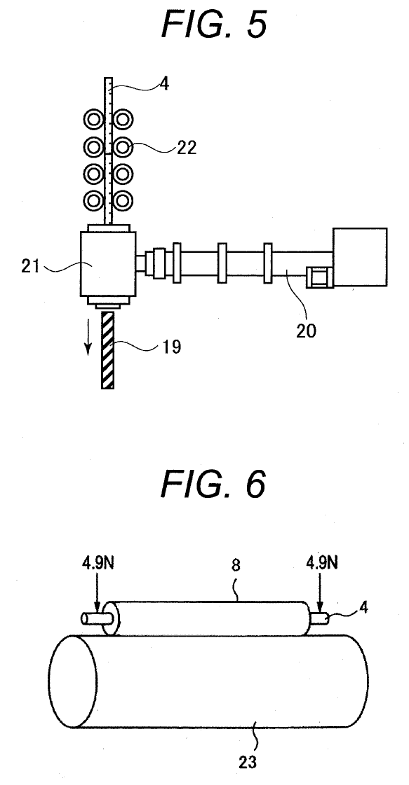

Then, the conductive support as a center axis was covered with the material rubber composition (compound for an elastic layer) coaxially in a cylindrical shape through use of an extrusion molding machine with a crosshead illustrated in FIG. 5 to obtain a charging member preparatory molded body 19 in which the outer diameter of the material rubber composition layer was a diameter (0 of mm. A crosshead 21 is a device generally used for covering an electric cable or a wire, and is used by being attached to a rubber discharging portion of a cylinder of an extruder 20.

Then, vulcanization and curing of the adhesive were performed with respect to the charging member preparatory molded body 19 in an electric oven at 160° C. for 1 hour. After both terminals of the rubber were cut to a rubber length of 228 mm, the surface was polished to a roller shape in which the outer diameter of a roller center portion was a diameter (0 of 8.5 mm to form an elastic layer on the conductive support, thereby obtaining an elastic roller. The crown amount (difference in outer diameter between the center portion and the position 90 mm away from the center portion) of the roller was 120 μm.

### Example 1

<Production of Charging Roller 1>

A mixed solution was produced based on the formulation described in Table 3.

TABLE 3

| | |
|---|---|
| Blocked polyrotaxane A-1 | 100 parts by mass |
| Conductive particles (produced in Production | 40 parts by mass |
| Example B-1) | |
| 1N sodium hydroxide aqueous solution | 500 parts by mass |

191.55 g of the mixed solution were placed in a glass bottle having an internal volume of 450 mL together with 200 g of glass beads each having a volume-average particle diameter of 0.8 mm as media and dispersed with a paint shaker disperser for 12 hours. After that, the glass beads were removed from the mixed solution.

A solution in which cyanuric chloride as a binder was dissolved in a 1 N sodium hydroxide aqueous solution was mixed in the blocked polyrotaxane solution in which the conductive particles were dispersed obtained by the above-mentioned operation. Thus, a coating solution for a surface layer was prepared.

The elastic roller produced in Production Example C-1 was subjected to dip coating once through use of the coating solution for a surface layer. The elastic roller was dried at normal temperature, and a binding reaction of the blocked polyrotaxane was performed to obtain a charging roller in which a surface layer made of a bound polyrotaxane was formed on an elastic roller.

In this case, the dip coating was performed so that the immersion time was 9 seconds, the initial dip coating lifting speed was 20 mm/s, the final dip coating lifting speed was 2 mm/s, and the speed was decreased linearly with time between the initial and final speeds. The bound polyrotaxane was identified by ¹H-NMR and GPC, and it was confirmed that intended polyrotaxane was obtained.

Separately, a sheet made of a fluororesin was coated with the coating solution for a surface layer to form a coating film, and drying of the coating film at normal temperature and the binding reaction of the blocked polyrotaxane were performed in the same way as in the above to form a thin layer made of the bound polyrotaxane on the sheet made of a fluororesin.

When the small-angle neutron scattering pattern of the obtained thin layer was observed while the obtained thin layer was stretched in a uniaxial direction together with the sheet made of a fluororesin, a normal butterfly pattern was observed. Further, a decrease in scattering intensity was found along with stretching.

In the case where a sheet made of an ordinary cross-linked rubber or the like is measured in the same way as in the above, fixed cross-linking sites are distributed in a non-uniform manner, and hence an abnormal butterfly pattern is observed. Further, non-uniformity increases along with stretching, and hence scattering intensity generally tends to increase. Further, the expression of the normal butterfly pattern and the decrease in scattering intensity are considered to be due to the following: the bound polyrotaxane according to this example takes an arrangement of alleviating a non-uniform structure and strain inside the thin layer in a self-organizing manner, because cross-linking sites move freely, and a loose bond is present as illustrated in FIG. 1.

<Evaluation of Charging Roller 1>

(Evaluation of Streak-Shaped Image Due to Banding)

As an electrophotographic apparatus having a configuration illustrated in FIG. 3, a color laser jet printer (trade name: HP Color LaserJet 4700dn) manufactured by Hewlett-Packard Co. Ltd.) was remodeled so as to have an output speed of a recording medium of 200 mm/sec (A4 vertical output) to be used. The image resolution was 600 dpi, and the output of primary charging is a DC voltage of −1,100 V.

As a process cartridge having a configuration illustrated in FIG. 4, a process cartridge (for black) for the printer was used.

An accompanying charging roller was removed from the above-mentioned process cartridge, and the charging roller 8 was set. The charging roller 8 was brought into abutment with the photosensitive member 23 under a spring pressure of 4.9 N at one end (total 9.8 N at both terminals) (FIG. 6).

The process cartridge was left to stand still for 12 hours or longer in an environment of a temperature of 15° C. and a humidity of 10% RH and mounted on the above-mentioned electrophotographic apparatus which was similarly left to stand still for 12 hours or more in an environment of a temperature of 15° C. and a humidity of 10% RH, and an image was output in the same environment. As an evaluation image, a half-tone image (image drawing horizontal lines at a width of one dot in a direction perpendicular to the rotation direction of the photosensitive member at an interval of two dots) was output. The output image was visually observed for the presence or absence of streaks due to banding and the degree thereof, and evaluated based on the criteria described in Table 4.

TABLE 4

| | |
|---|---|
| Rank A | No streaks are recognized |
| Rank B | Slight streaks are recognized |
| Rank C | Clear streaks are recognized |

(Evaluation of Streak-Shaped Image Due to C Set)

The charging roller 8 was set in a process cartridge different from the process cartridge which was evaluated for an image as described above, and the process cartridge was left to stand still for 1 month in an environment of a temperature of 40° C. and a humidity of 95% RH. Next, after the process cartridge was left to stand still for 6 hours in an environment of a temperature of 23° C. and a humidity of 50% RH, the process cartridge was mounted on the electrophotographic apparatus, and an image was output in the same environment. As an evaluation image, a half-tone image (image drawing horizontal lines at a width of one dot in a direction perpendicular to the rotation direction of the photosensitive member at an interval of two dots) was output. The output image was observed visually for the presence or absence of a streak-shaped image due to a C set and the degree thereof and evaluated based on the criteria described in Table 5.

TABLE 5

| | |
|---|---|
| Rank A | No generation of streaks is recognized. |
| Rank B | The generation of streaks is slightly |
| | recognized. |
| Rank C | The generation of streaks is clearly |
| | recognized. |

(Measurement of C Set Amount)

After outputting an image, the charging roller 8 was taken out from the process cartridge, and radii of the charging roller in an abutment portion and a non-abutment portion with respect to the photosensitive member were respectively measured. For the measurement, an automatic roller measurement apparatus manufactured by Tokyo Opto-Electronics Co., Ltd. was used.

Regarding three positions: a center position in a longitudinal direction of the charging roller, and positions 90 mm away from the center position to the left and right, the charging roller 1 was rotated by 1° each time, and the positions corresponding to the abutment portion and the non-abutment portion were measured. Next, a difference between a maximum value of the radius of the non-abutment portion and a minimum value of the radius of the abutment portion was calculated. A value at which the difference in radius was largest of the three portions was defined as a C set amount.

### Examples 2 to 20

<Production and Evaluation of Charging Rollers 2 to 20>

Charging rollers 2 to 20 were obtained by the same method as that of Example 1 with the exception that that the blocked polyrotaxane and the binder were changed as described in Table 6. The charging rollers were evaluated in the same way as in the evaluation method for the charging roller 1 described in Example 1.

TABLE 6

| | Charging | Production example of | |
|---|---|---|---|
| Example | roller No. | blocked polyrotaxane | Binder |
| 1 | 1 | A-1 | Cyanuric chloride |
| 2 | 2 | A-1 | Tetraethoxysilane |
| 3 | 3 | A-1 | 1,1-Carbonyldimidazole |
| 4 | 4 | A-1 | 2,4-Tolylene |
| | | | diisocyanate |
| 5 | 5 | A-1 | Tetraethoxysilane |
| 6 | 6 | A-2 | Cyanuric chloride |
| 7 | 7 | A-3 | Cyanuric chloride |
| 8 | 8 | A-4 | Cyanuric chloride |
| 9 | 9 | A-5 | Cyanuric chloride |
| 10 | 10 | A-6 | Cyanuric chloride |
| 11 | 11 | A-7 | Cyanuric chloride |
| 12 | 12 | A-8 | Cyanuric chloride |
| 13 | 13 | A-9 | Cyanuric chloride |
| 14 | 14 | A-10 | Cyanuric chloride |
| 15 | 15 | A-11 | Cyanuric chloride |
| 16 | 16 | A-12 | Cyanuric chloride |
| 17 | 17 | A-13 | Cyanuric chloride |
| 18 | 18 | A-14 | Cyanuric chloride |
| 19 | 19 | A-15 | Cyanuric chloride |
| 20 | 20 | A-16 | TDI |

TDI: tolylene diisocyanate

### Comparative Example 1

<Production and Evaluation of Charging Roller 21>

A charging roller 21 was obtained in the same way as in Example 1 with the exception that no binder was used. The charging roller was evaluated in the same way as in the evaluation method for the charging roller 1 described in Example 1.

### Comparative Example 2

<Production and Evaluation of Charging Roller 22>

A pseudorotaxane was prepared in the same way as in the pseudorotaxane produced in Production Example A-1. The pseudorotaxane was defined as a pseudorotaxane 17. A charging roller 22 was obtained in the same way as in the charging roller 1 with the exception that the pseudorotaxane 17 was used instead of the blocked polyrotaxane A-1, and the binder was not used. The charging roller was evaluated in the same way as in the evaluation method for the charging roller 1 described in Example 1.

### Comparative Example 3

<Production and Evaluation of Charging Roller 23>

A charging roller 23 was obtained in the same way as in Example 1 with the exception that a mixture described in Table 7 was used instead of the blocked polyrotaxane A-1. The charging roller was evaluated in the same way as in the evaluation method for the charging roller 1 described in Example 1.

TABLE 7

| | |
|---|---|
| PEG (weight-average molecular weight: | 50 parts by mass |
| 10,000) | |
| α-Cyclodextrin | 50 parts by mass |
| 2,4-Dinitrofluorobenzene | 2 parts by mass |
| Cyanuric chloride | 3 parts by mass |

Table 8 shows the evaluation results of Examples 1 to 20 and Comparative Examples 1 to 3.

TABLE 8

| | | | Streak- | Streak-shaped | |
|---|---|---|---|---|---|
| | | | shaped | image due | Permanent |
| | | Charging | image due | to permanent | deformation |
| | | roller No. | to banding | deformation | amount/μm |
| Example | 1 | 1 | A | A | 5.5 |
| | 2 | 2 | A | A | 5.6 |
| | 3 | 3 | A | A | 5.8 |
| | 4 | 4 | A | A | 5.5 |
| | 5 | 5 | A | A | 5.7 |
| | 6 | 6 | A | A | 6.0 |
| | 7 | 7 | A | A | 6.1 |
| | 8 | 8 | A | A | 6.2 |
| | 9 | 9 | A | A | 5.4 |
| | 10 | 10 | A | A | 5.0 |
| | 11 | 11 | A | A | 5.6 |
| | 12 | 12 | A | A | 5.7 |
| | 13 | 13 | A | A | 5.8 |
| | 14 | 14 | A | A | 4.5 |
| | 15 | 15 | A | A | 6.0 |
| | 16 | 16 | A | A | 5.8 |
| | 17 | 17 | A | A | 5.0 |
| | 18 | 18 | A | A | 5.0 |
| | 19 | 19 | A | A | 5.6 |
| | 20 | 20 | A | B | 10.0 |
| Comparative | 1 | 21 | B | C | 13.0 |
| Example | 2 | 22 | C | C | 14.0 |
| | 3 | 23 | C | C | 15.0 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2011-277619 filed on Dec. 19, 2011, the content of which is hereby incorporated by reference.

What is claimed is:

1. A charging member, comprising:
an electrically conductive support; and
an electrically conductive surface layer,
wherein:
the surface layer comprises a bound substance in which a first polyrotaxane and a second polyrotaxane are bound;
the first polyrotaxane has a structure in which
a first straight-chain molecule passes through an inside of a ring of a first cyclic molecule, and
the first straight-chain molecule has two blocking groups and the blocking groups are disposed at both terminals of the first straight-chain molecule so as to prevent the first cyclic molecule from being detached from the first straight-chain molecule;
the second polyrotaxane has a structure in which
a second straight-chain molecule passes through an inside of a ring of a second cyclic molecule, and
the second straight-chain molecule has two blocking groups and the blocking groups are disposed at both terminals of the second straight-chain molecule so as to prevent the second cyclic molecule from being detached from the second straight-chain molecule; and wherein:
the first polyrotaxane and the second polyrotaxane are bound by forming a chemical bond between the first cyclic molecule and the second cyclic molecule.

2. The charging member according to claim 1, wherein the cyclic molecule comprises at least one cyclodextrin molecule selected from the group consisting of α-cyclodextrin, β-cyclodextrin, and γ-cyclodextrin.

3. The charging member according to claim 1, wherein the straight-chain molecule comprises at least one selected from the group consisting of polyethylene glycol, polypropylene glycol, polyisoprene, and polybutadiene.

4. A process cartridge, comprising:
the charging member according to claim 1; and
an electrophotographic photosensitive member disposed so as to be chargeable by the charging member,
the process cartridge being attachable to and detachable from a main body of an electrophotographic apparatus.

5. An electrophotographic apparatus, comprising:
the charging member according to claim 1;
an electrophotographic photosensitive member disposed so as to be chargeable by the charging member;
an exposing device; and
a fixing device.
